(19) United States
(12) Patent Application Publication
(10) Pub. No.: US 2001/0043015 A1
(43) Pub. Date: Nov. 22, 2001

(54) Electric system having electrical module to be swapped

(76) Inventors: Nick Chang, Taoyuan Shien (TW); Chin-Chu Huang, Taoyuan Shien (TW)

Correspondence Address: CHRISTIE, PARKER & HALE, LLP, 350 WEST COLORADO BOULEVARD, SUITE 500, PASADENA, CA, 91105, US

(21) Appl. No.: 09/874,825

(22) Filed: Jun. 5, 2001

Related U.S. Application Data
(63) Continuation-in-part of application No. 09/450,828, filed on Nov. 29, 1999, now abandoned.

(30) Foreign Application Priority Data
Dec. 1, 1998 (TW) 87220014

(51) Int. Cl. H02J 4/00

(52) U.S. Cl. 307/326

(57) ABSTRACT

An electric system having electrical module which can be hot swapped is comprised of a system frame having a plurality of first connectors, and a plurality of electrical modules each of which includes a second connector respectively connected to one of the first connectors and is swappable from the system frame. Each of the first connectors is provided with a plug part including conductive socket pieces and the second connector includes conductive projecting pieces for contacting the plug part. In particular, both of the first connector and the second connector are compliant with the requirements defined in IEC320 safety regulation.

This application is a continuation-in-part application of the application Ser. No. 09/450,828, filed on Nov. 29, 1999.

### FIELD OF THE INVENTION

The present invention is directed to an electric system having electrical modules which can be hot swapped during operation.

### DESCRIPTION OF THE RELATED ART

The prior art power supply system with power modules received therein is typically equipped with a juxtaposed connector pair. The juxtaposed connector pair comprises a high voltage connector and a low voltage connector, wherein the former is located alongside the latter. However, the arrangement of the juxtaposed connector pair provided by the prior art power supply system will cause a signal interference between the two voltage connectors. And what is worse, the juxtaposed connector pair provided by the prior art power supply system in is quite long and is unavoidably to be extracted from and/or plugged in the power supply system by the operator frequently, which will lead to loose contact.

As shown in FIG. 1, the power module 1 is equipped with a juxtaposed connector pair 2 on the side of the power module 1. The juxtaposed connector pair 2 comprises a high voltage connector 3 provided for connecting to a power source, such as a 110-V AC power source, and a low voltage connector 4 provided for connecting to a signal source, such as a 5-V DC power source. Nevertheless, the arrangement of the connector pair 2 of the power module 1 always brings about the unsteadiness of the signal at the low voltage connector 4 due to the signal interference taken place between the two voltage connectors.

As depicted in FIG. 2, the contemporary power module 1 is equipped with a juxtaposed connector pair, which comprises a high voltage connector 3 and a low voltage connector 4 being separated from each other and disposed on the side of the power module 1. Compared to the power module of FIG. 1, though the arrangement of the juxtaposed connector pair shown in FIG. 2 can suppress the signal interference at the low voltage connector, the problem of loose contact still can not be eliminated. In addition, the high voltage connector can not be anchored to the system frame of the power supply system. Therefore, there is a need for the connector for use with the power supply system to modify the arrangement of connector used in the conventional power supply system to overcome the aforementioned defects encountered by the prior art.

### SUMMARY OF THE INVENTION

An object of the present invention is to provide an electric system with electrical modules which can be hot swapped from the system frame of the electric system.

Another object of the present invention is to provide a connector arrangement which can comply with the prescriptions defined in IEC320 safety regulation.

Broadly speaking, the electric system according to an embodiment of the present invention comprises a system frame having a plurality of first connectors, and a plurality of electrical modules which can be swapped during the system operation, each of which is equipped with a second connector for respectively mating with one of the first connectors. Each of the first connectors comprises a plurality of copper-made conductive socket pieces, and the second connector comprises a plurality of copper-made conductive projecting pieces being received in a receiving hole of the electrical module. Remarkably, both of the first connector and the second connector are compliant with the requirements defined in IEC320 safety regulation.

Further, several apertures are embraced in the system frame of the electric system for permitting the first connectors to be anchored to the system frame. In particular application with the connector arrangement of the electric system, the electrical module further includes a low voltage connector which is adapted to transmit a low voltage signal.

Now the foregoing and other features and advantages of the present invention will be more clearly understood through the following descriptions with reference to the accompanying drawings, in which:

### BRIEF DESCRIPTION OF THE DRAWINGS

FIG. 1 shows the power supply system provided with a juxtaposed connector pair comprising a high voltage connector and a low voltage connector according to the prior art.

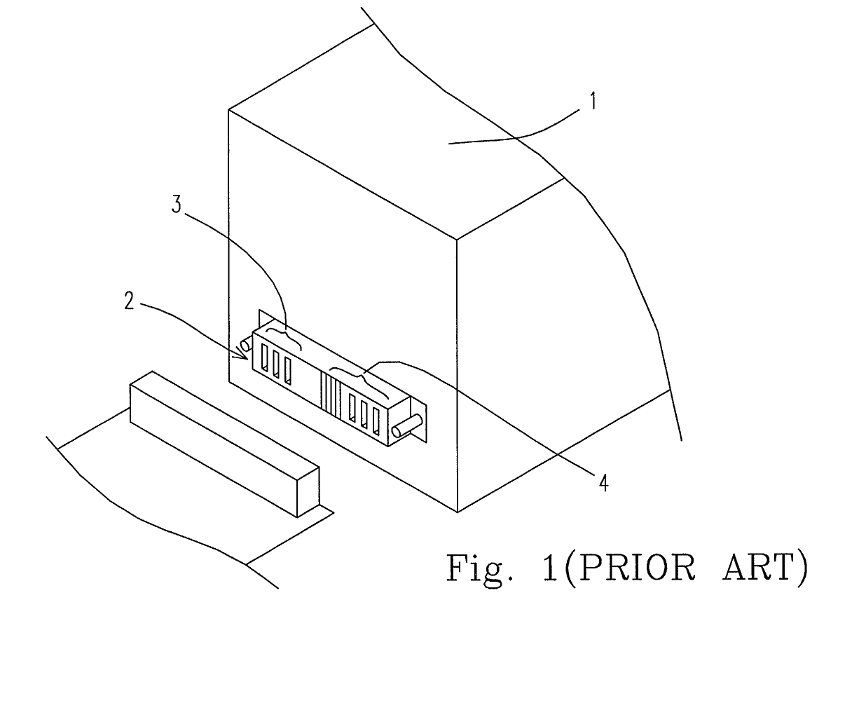

FIG. 2 shows the power supply system provided with a connector pair, with the connector arrangement is obtained by separating the high voltage connector from the low voltage connector of the power supply system of FIG. 1.

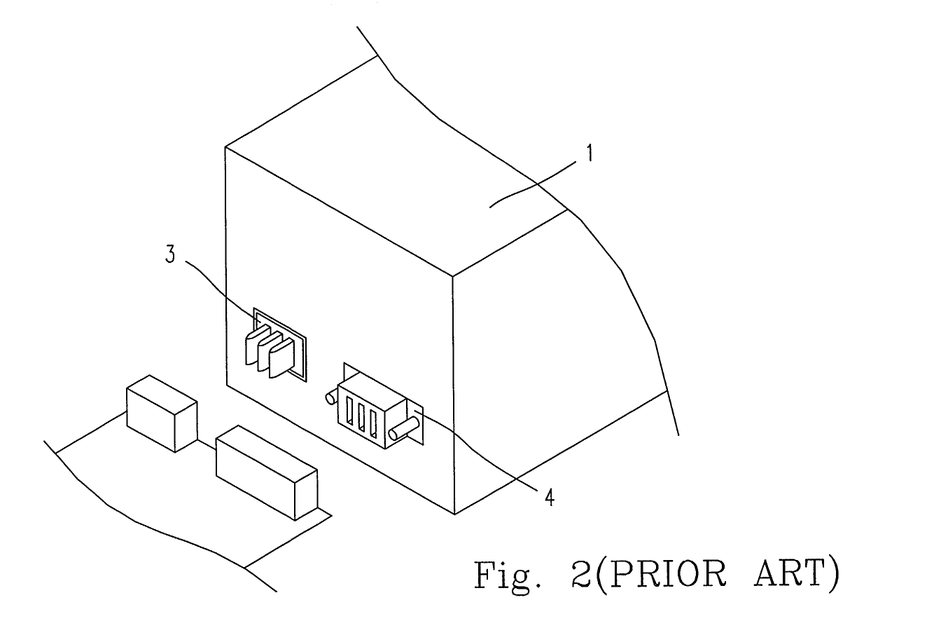

FIG. 3 is an exploded perspective view showing the power supply system with hot swappable power module received therein according to the present invention, view along the backside of the power module.

FIG. 4 is a schematic diagram showing a preferred embodiment of power supply system, in which the power module is in cooperation with the system frame by means of a first connector and a second connector.

FIG. 5 is a detailed drawing of the first connector shown in FIG. 4.

### DETAILED DESCRIPTION OF THE PREFERRED EMBODIMENT

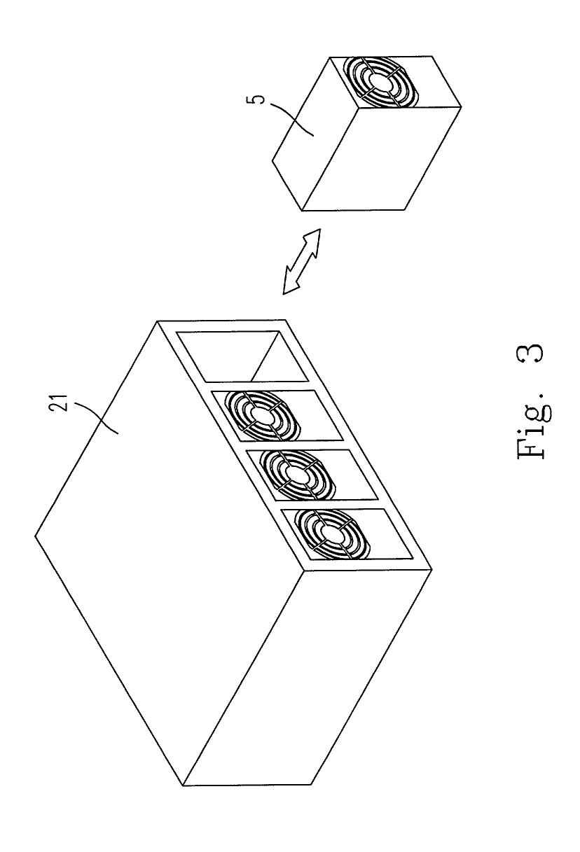

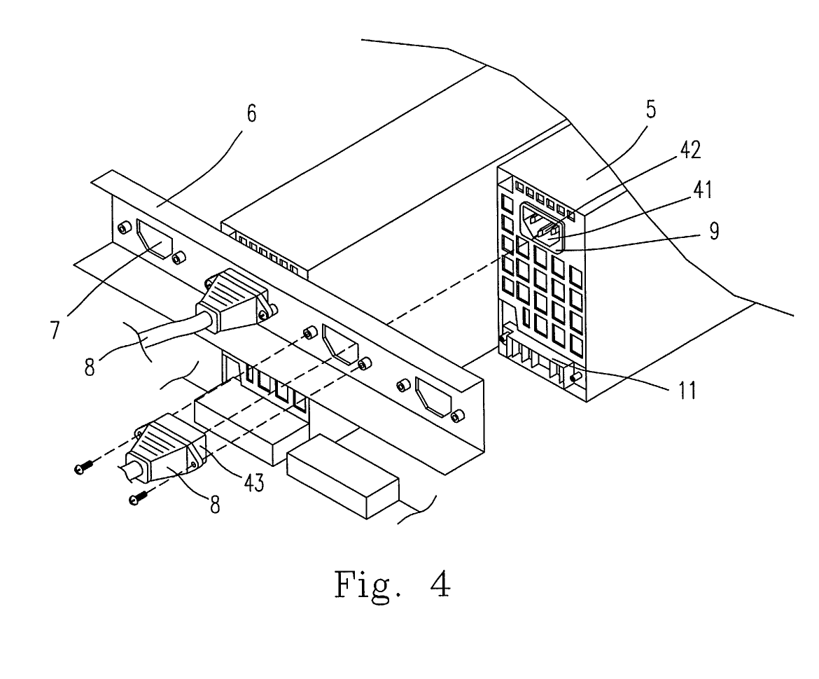

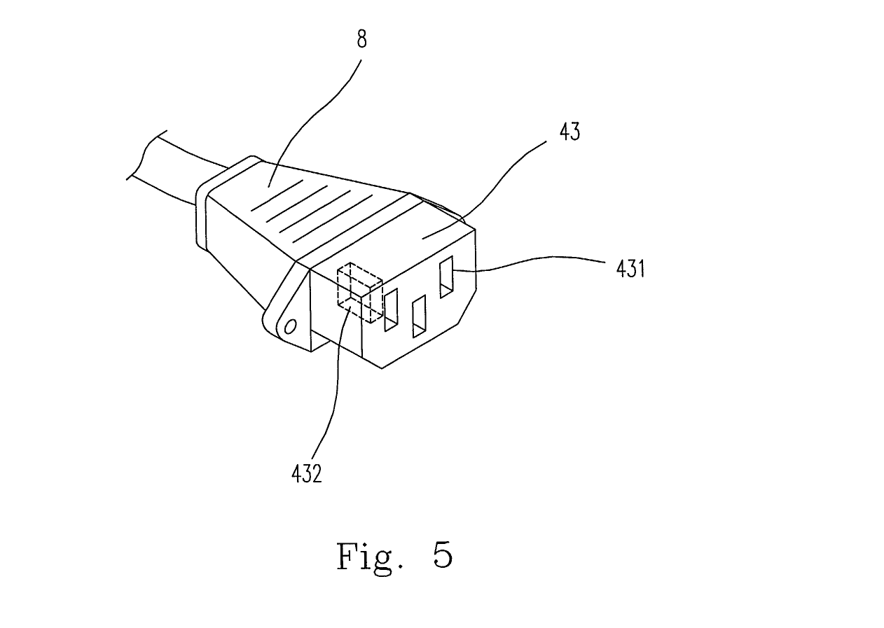

The power supply system with hot swappable power modules embodying the present invention will now be illustrated by the following descriptions and the accompanying FIG. 3, FIG. 4, and FIG. 5. Referring now to FIG. 3, the power supply system 21 includes a plurality of power modules 5 which are adapted for hot-swapped application, which means that the power modules 5 can be swapped from the power supply system 21 during the system operation. FIG. 4 depicts the internal system structure of power supply system of the present invention. In FIG. 4, the power supply system comprises a system frame 6 and power modules 5. The system frame 6 has a plurality of first connectors 8, and each of the power modules 5 has a second connector 9. The second connectors 9 is connected to one of the first connectors 8 and is swappable from the system frame 6. Each of the first connector 8 provides a plug part 43 comprising copper-made conductive socket pieces 432 (which is shown in FIG. 5), and the second connector 9 provides copper-made conductive projecting pieces 42 being received in a receiving hole 41 for contacting with the plug part 43 of the first connector 8. In the embodiment of FIG. 4, each of the first connector 8 includes three holes 431 (which can be seen from FIG. 5) for respectively receiving the conductive projecting pieces 42. In this manner, the power module 5 can be extracted from/plugged in the system frame 6 softly, above all, the power module 5 can support the hot-swap functionality accordingly.

The system frame 6 is provided with several apertures 7 configured for anchoring the first connector thereto. The first connector 8 are designated as female connectors. By contrast, the second connector 9 which has three conductive projecting pieces 42 embedded in a receiving hole 41 acts as a male connector which is designed for mating with the female connector 8. In particular, both of the first connector 8 and second connectors 9 are compliant with the prescriptions defined in IEC320 safety regulation.

The power module 5 further includes a low voltage connector 11. The low voltage connector 11 is used to permit the low voltage signals to be transmitted therefrom, and the high voltage connector which is directed to the second connector 9 is used to sustain an AC power.

To the brief, the present invention is highlighted in the respect of the connector arrangement of the electric system. In accordance with the present invention, the power supply system is comprised of a system frame having a plurality of first connectors, and a plurality of power modules each of which includes a second connector respectively connected to one of the first connectors. Each of the first connectors is provided with a plug part comprising conductive socket pieces and the second connectors comprises conductive projecting pieces for contacting the plug part, in such a configuration that the first connector and the second connector can comply with the requirements defined in IEC320 safety regulation. Therefore, the connection between the power module and the system frame is more secure and reliable, and the signal interference can be eliminated thoroughly. Further, the operator will not contact the metal part of the high voltage connector, in order that the connector configuration is capable of protecting the human body from getting electric shock. It can be known that the IEC320 connector are commercially available, therefore it is unnecessary to redesign the connector and the manufacturing cost can be reduced significantly.

Those of skill in the art will recognize that these and other modifications can be made within the spirit and scope of the invention as defined in the appended claims.

What is claimed is:

1. An electric system having electrical modules to be swapped, comprising:
a system frame having a plurality of first connectors; and
a plurality of electrical modules, each of which includes a second connector respectively connected to one of said first connectors and being swapped from said system frame, wherein each of said first connectors is provided with a plug part including conductive socket pieces and said second connector includes conductive projecting pieces for contacting with said plug part.

2. The electric system as claimed in claim 2, wherein both of said conductive socket pieces and said conductive projecting pieces are made of copper.

3. The electric system as claimed in claim 1, wherein said system frame further comprises a plurality of apertures, each of which is provided to anchor one of said first connectors thereto.

4. The electric system as claimed in claim 1, wherein said electrical module further comprises a receiving hole for receiving said second connector.

5. The electric system as claimed in claim 1, wherein both of said first connector and said second connector are compliant with the prescriptions defined in IEC320 safety regulation.

6. The electric system as claimed in claim 1, wherein said electrical module further comprises a low voltage connector for permitting a low voltage signal to be transmitted therefrom.
